(19) United States
(12) Patent Application Publication
(10) Pub. No.: US 2012/0146445 A1
(43) Pub. Date: Jun. 14, 2012

(54) Axial Flux Permanent Magnet Brushless Machine

(75) Inventors: Hirooki TOKOI, Naka-gun (JP); Yuji ENOMOTO, Hitachi-shi (JP)

(73) Assignee: Hitachi, Ltd., Tokyo (JP)

(21) Appl. No.: 13/323,513

(22) Filed: Dec. 12, 2011

(30) Foreign Application Priority Data
Dec. 13, 2010 (JP) 2010-276517

(51) Int. Cl. H02K 21/24

(52) U.S. Cl. 310/156.37

(57) ABSTRACT

An axial flux permanent magnet brushless machine according to the present invention includes: a housing; a stator comprising a stator core and a coil; two rotors each including a permanent magnet, and positioned so as to sandwich the stator in the axial direction with air gaps being left between the rotors and the stator; and a variable gap mechanism for changing distances of the air gaps; wherein the variable gap mechanism operates from a power source that supplies other rotational power than a rotational power of the axial flux permanent magnet brushless machine, and changes the distances of the air gaps by shifting the rotors in the axial direction.

### INCORPORATION BY REFERENCE

The disclosure of the following priority application is herein incorporated by reference: Japanese Patent Application No. 2010-276517, filed Dec. 13, 2010.

### BACKGROUND OF THE INVENTION

1. Field of the Invention

The present invention relates to an axial flux permanent magnet brushless machine, in which a stator and a rotor oppose one another in the axial direction with an air gap being defined between them.

2. Description of the Related Art

In a rotating electrical machine in which a permanent magnet is provided to a rotor, an induced voltage is generated during rotation. It is necessary for the power supply voltage for such a rotating electrical machine (i.e. the inverter output voltage) to be greater than or equal to this induced voltage, since the induced voltage increases in proportion to the rotational speed.

In order to suppress increase of the induced voltage with an axial flux permanent magnet brushless machine, which is a type of a rotating electrical machine and is also referred hereafter as an axial gap type rotating electrical machine, a technique is per se known of increasing the air gap between the stator and the rotor during high speed rotation, thus increasing the magnetic reluctance.

In Japanese Laid-Open Patent Publication 2002-325412, for example, a rotating electrical machine is described that has a variable gap mechanism consisting of a pendulum connected to the rotor and a force conversion mechanism. With this force conversion mechanism, this variable gap mechanism converts centrifugal force generated in the pendulum due to rotation of the rotor into force in the axial direction, and applies this force to the stator. Due to this, it is possible to adjust the air gap by the stator shifting according to the rotational speed of the rotor.

Furthermore, in Japanese Laid-Open Patent Publication 2008-48519, a rotating electrical machine is described that has a variable gap mechanism consisting of a stator having a fixed portion that is fixed irrespective of rotation of the rotor and a tooth portion provided with a screw mechanism, and a translation mechanism that moves the tooth portion by rotating it. With this variable gap mechanism, it is possible to adjust the gap size of the air gap by moving a tooth of the stator by rotating it, according to the rotational speed of the rotor, thus adjusting the induced voltage.

### SUMMARY OF THE INVENTION

With the structure of Japanese Laid-Open Patent Publication 2002-325412, almost no consideration is given to flexible control of the gap distance, since the gap distance depends upon the rotational speed of the rotor, or upon the coil current that is supplied for rotation of the rotor. Moreover, since the variable gap mechanism is complicated, accordingly there is a possibility that the construction of the rotating electrical machine may become complicated in order to ensure good strength and good heat dissipation performance.

On the other hand, with the structure of Japanese Laid-Open Patent Publication 2008-48519, it is possible to control the gap distance in a flexible manner, since an external power source is employed. However, it is difficult to apply this structure to a rotating electrical machine of a double rotor construction, since the stator core has a divided construction.

Accordingly, the object of the present invention is to provide an axial gap type rotating electrical machine of a double rotor construction, in which the reliability of the variable gap mechanism is enhanced, and in which it is possible to change the gap distance between the stator and the rotor in a flexible manner.

According to the 1st aspect of the present invention, an axial flux permanent magnet brushless machine comprises: a housing; a stator comprising a stator core and a coil; two rotors each including a permanent magnet, and positioned so as to sandwich the stator in the axial direction with air gaps being left between the rotors and the stator; and a variable gap mechanism for changing distances of the air gaps; wherein the variable gap mechanism operates from a power source that supplies other rotational power than a rotational power of the axial flux permanent magnet brushless machine, and changes the distances of the air gaps by shifting the rotors in the axial direction.

According to the 2nd aspect of the present invention, an axial flux permanent magnet brushless machine comprises: a housing; a stator comprising a stator core and a coil; two rotors each including a output shaft and a permanent magnet, and positioned so as to sandwich the stator in the axial direction with air gaps being left between the rotors and the stator; a variable gap mechanism for changing distances of the air gaps; and a power source that supplies other rotational power than a rotational power of the axial flux permanent magnet brushless machine, and drives the variable gap mechanism; wherein the variable gap mechanism comprises two shifting shafts each with a screw portion and a gear portion and two nut portions each supporting the screw portion, and the screw portion is connected to the power source, and the variable gap mechanism shift the rotors due to movement of the shifting shafts each by rotation of the screw portion by the power source.

According to the 3rd aspect of the present invention, in an axial flux permanent magnet brushless machine according to the 2nd aspect, it is preferred that the rotors comprise connection portions that are connected with the shifting shafts; and the connecting portions include thrust bearings provided on a surface to which the shifting shafts are connected, so that the rotors can rotate assuming the output shaft as its rotation axis.

According to the 4th aspect of the present invention, in an axial flux permanent magnet brushless machine according to the 3rd aspect, it is preferred that the engagement portions include bearings provided on the sides of the shifting shafts towards the rotors, so that the rotors can rotate assuming the output shaft as its rotation axis.

According to the 5th aspect of the present invention, in an axial flux permanent magnet brushless machine according to the 2nd aspect, it is preferred that the variable gap mechanism is disposed at the external periphery of the stator, and the screw portion of one the two shifting shafts is reverse threaded against the screw portion of the other one of the two shifting shafts, and the two nut portions are fixed to the stator.

According to the 6th aspect of the present invention, in an axial flux permanent magnet brushless machine according to the 2nd aspect, it is preferred that the variable gap mechanism is disposed at the internal periphery of the stator, and the screw portion of one the two shifting shafts is reverse threaded against the screw portion of the other one of the two shifting shafts, and the two nut portions are fixed to the stator.

According to the 7th aspect of the present invention, in an axial flux permanent magnet brushless machine according to the 6th aspect, it is preferred that the output shaft comprises two output shafts each provided to respective rotors, each of the two output shafts is connected via a ball spline mechanisms to the respective rotor, and in the interiors of the two output shafts, power transmission mechanisms that transmit power from the power source to the screw portion of the shifting shaft.

According to the 8th aspect of the present invention, in an axial flux permanent magnet brushless machine according to the 7th aspect, it is preferred that the power transmission mechanism comprises a first gear that is connected to the power source and a second gear that is the gear portion of the shifting shaft, and power of the power source is transmitted by engaging the first gear and the second gear.

According to the 9th aspect of the present invention, in an axial flux permanent magnet brushless machine according to the 6th aspect, it is preferred that the two output shafts are coupled to a single external output shaft exterior to the housing.

According to the 10th aspect of the present invention, in an axial flux permanent magnet brushless machine according to the 6th aspect, it is preferred that a rotor coupling mechanism is provided between the two rotors and mechanically fixes their relative position in the rotational direction.

According to the 11th aspect of the present invention, in an axial flux permanent magnet brushless machine according to the 10th aspect, it is preferred that the rotor coupling mechanism is a cylinder.

According to the 12th aspect of the present invention, in an axial flux permanent magnet brushless machine according to the 2nd aspect, it is preferred that the rotor core is made from magnetic steel sheet, amorphous metal, or electromagnetic stainless steel.

According to the 13th aspect of the present invention, in an axial flux permanent magnet brushless machine according to the 2nd aspect, it is preferred that the permanent magnet is an annular polar anisotropy magnetized magnet.

According to the 14th aspect of the present invention, in an axial flux permanent magnet brushless machine according to the 2nd aspect, it is preferred that the stator core is made from magnetic steel sheet, amorphous metal, or electromagnetic stainless steel.

According to the 15th aspect of the present invention, in an axial flux permanent magnet brushless machine according to the 2nd aspect, it is preferred that the power source is a servomotor.

### BRIEF DESCRIPTION OF THE DRAWINGS

FIG. 1 is an axial sectional view of a first embodiment of the axial gap type rotating electrical machine according to the present invention;

FIG. 2 is a diametrical sectional view of the first embodiment of the axial gap type rotating electrical machine according to the present invention;

FIG. 3 is an external perspective view of the first embodiment of the axial f gap type rotating electrical machine according to the present invention;

FIG. 4 is an angled sectional view for explanation of the internal structure of the rotating electrical machine of FIG. 3;

FIG. 5A is an axial sectional view of the first embodiment of the axial gap type rotating electrical machine according to the present invention (when its gap distance is of normal operation);

FIG. 5B is a figure showing, for convenience of understanding, the state of the right half of the rotating electrical machine of FIG. 5A, when its gap distance has been increased;

FIG. 6 is an axial sectional view of a second embodiment of the axial gap type rotating electrical machine according to the present invention;

FIG. 7 is an axial sectional view of a third embodiment of the axial gap type rotating electrical machine according to the present invention;

FIG. 8A is an axial sectional view of a fourth embodiment of the gap type rotating electrical machine according to the present invention (when its gap distance is of normal operation);

FIG. 8B is a figure showing the state of the rotating electrical machine of FIG. 8A, when its gap distance has been increased;

FIG. 9A is an axial sectional view of a fifth embodiment of the axial gap type rotating electrical machine according to the present invention (when its gap distance is of normal operation);

FIG. 9B is a figure showing the state of the rotating electrical machine of FIG. 9A, when its gap distance has been increased;

FIG. 10 is a figure showing a relationship between rotational speed and voltage and torque, and serves for explanation of the beneficial effect, with the axial gap type rotating electrical machine according to the present invention, of increasing the gap distance;

FIG. 11 is a figure showing a relationship between rotational speed and gap distance, and serves for explanation of the beneficial effect, with the axial gap type rotating electrical machine according to the present invention, of increasing the gap distance;

FIG. 12 is a figure showing a relationship between rotational speed and voltage and torque when control is performed in a discrete manner (i.e. stepwise), and serves for explanation of the beneficial effect, with the axial gap type rotating electrical machine according to the present invention, of increasing the gap distance; and

FIG. 13 is a figure showing a relationship between rotational speed and gap distance when control is performed in a discrete manner, and serves for explanation of the beneficial effect, with the axial gap type rotating electrical machine according to the present invention, of increasing the gap distance.

### DESCRIPTION OF THE PREFERRED EMBODIMENTS

In the following, embodiments of the axial flux permanent magnet brushless machine, which is referred as an axial gap type rotating electrical machine, according to the present invention will be explained with reference to the drawings.

### Embodiment #1

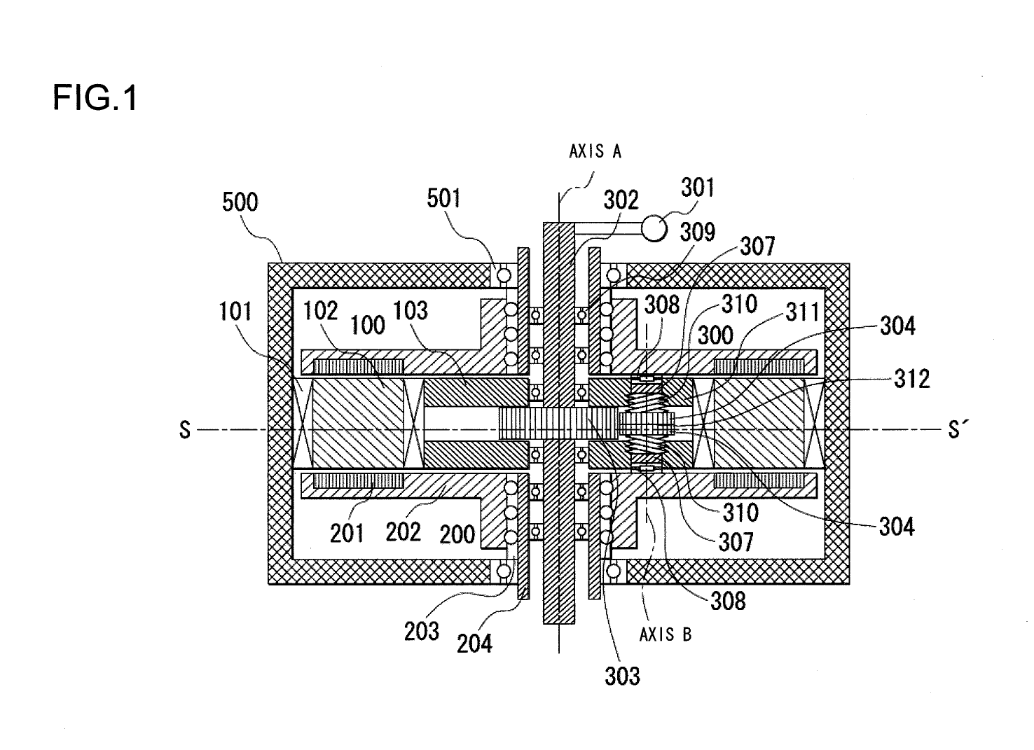

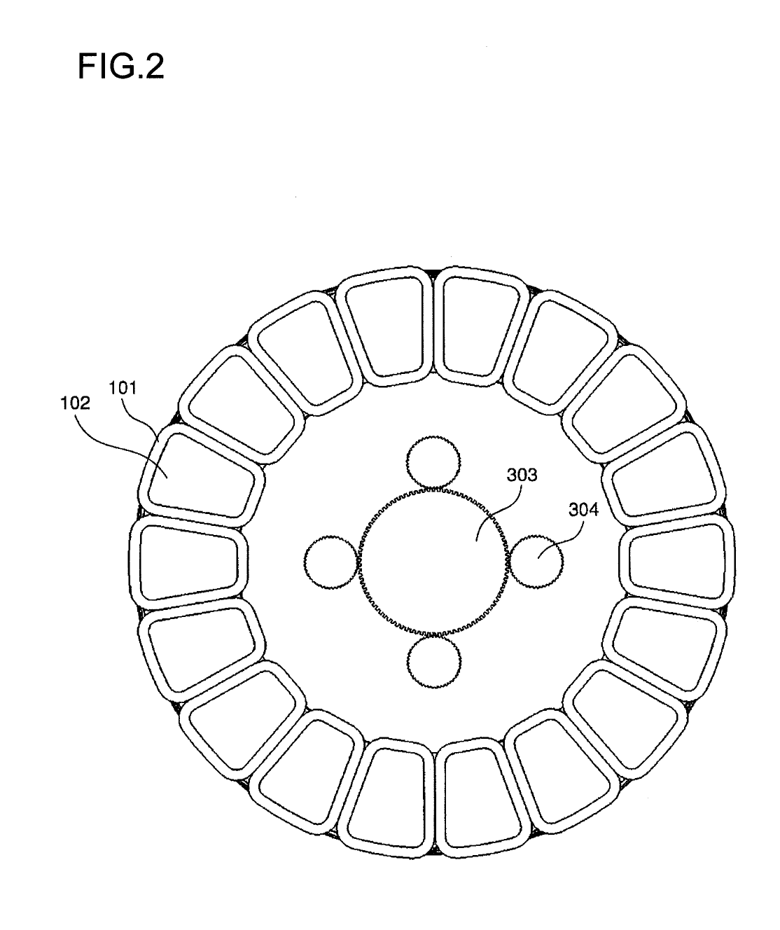

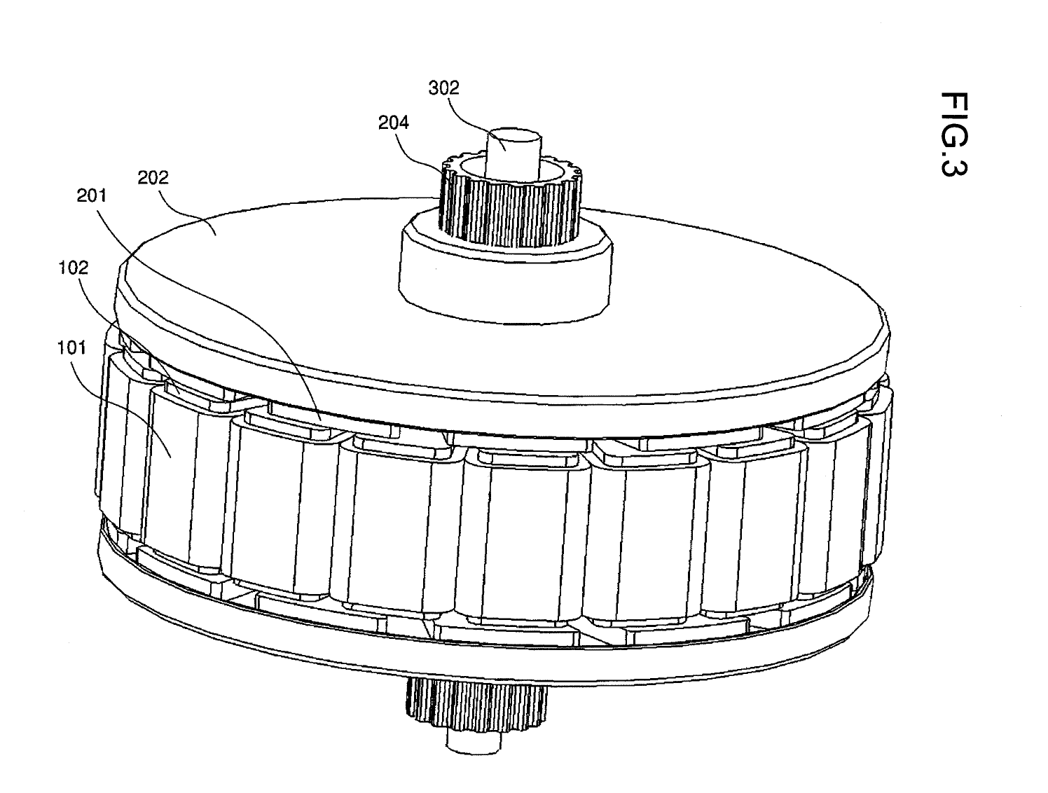

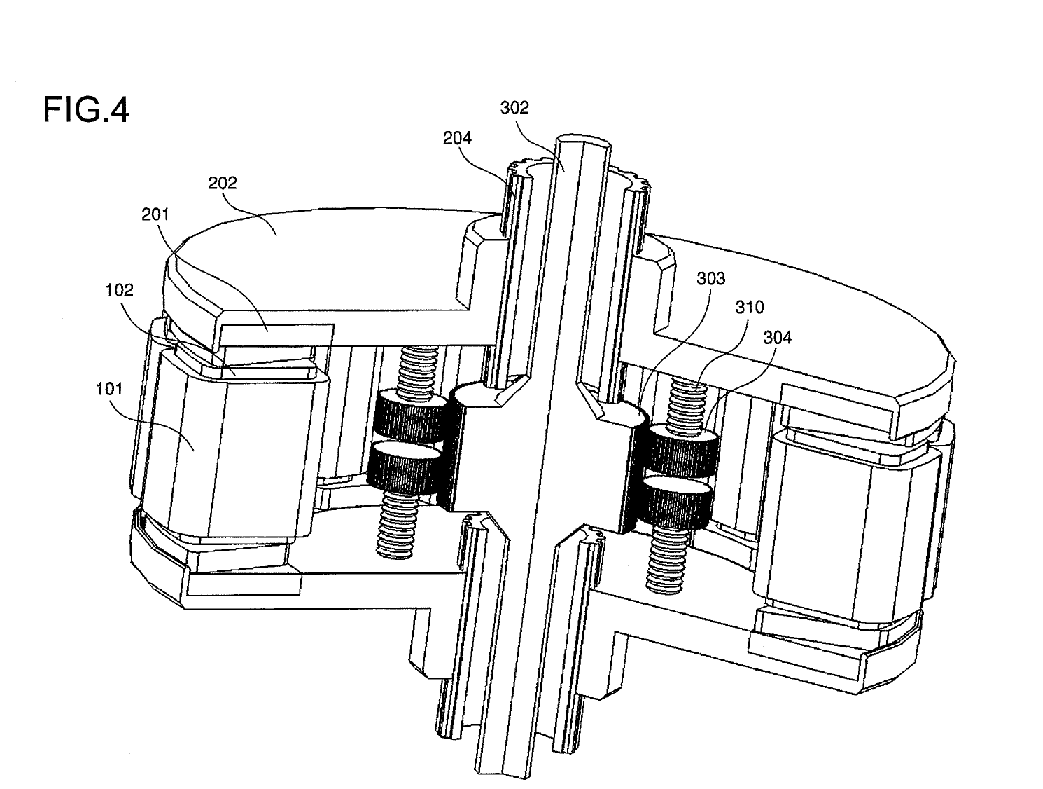

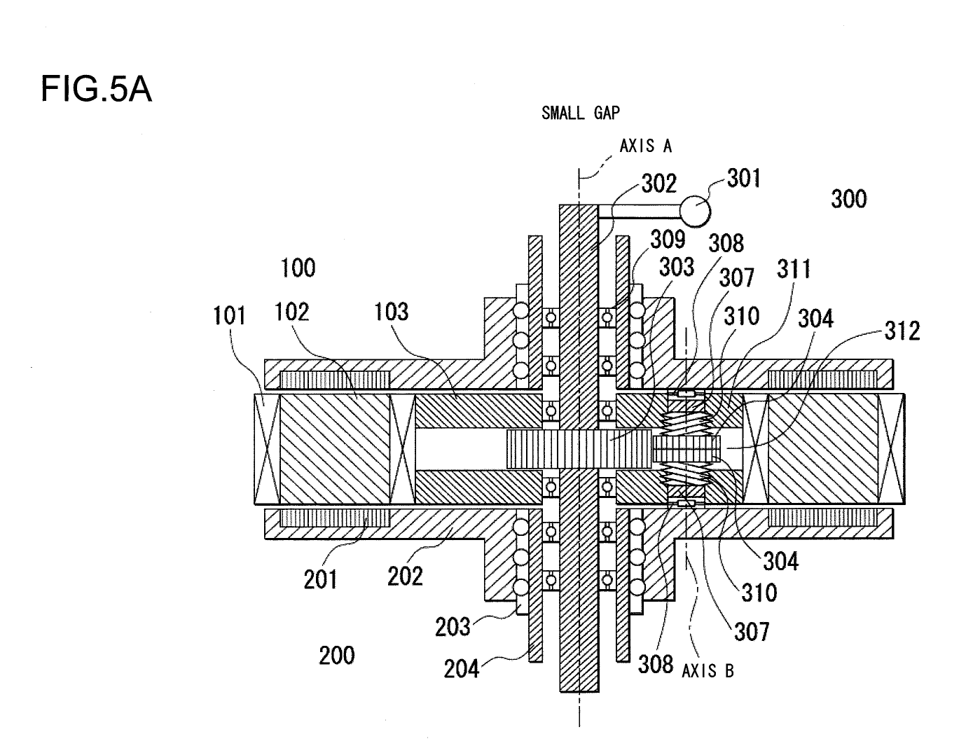

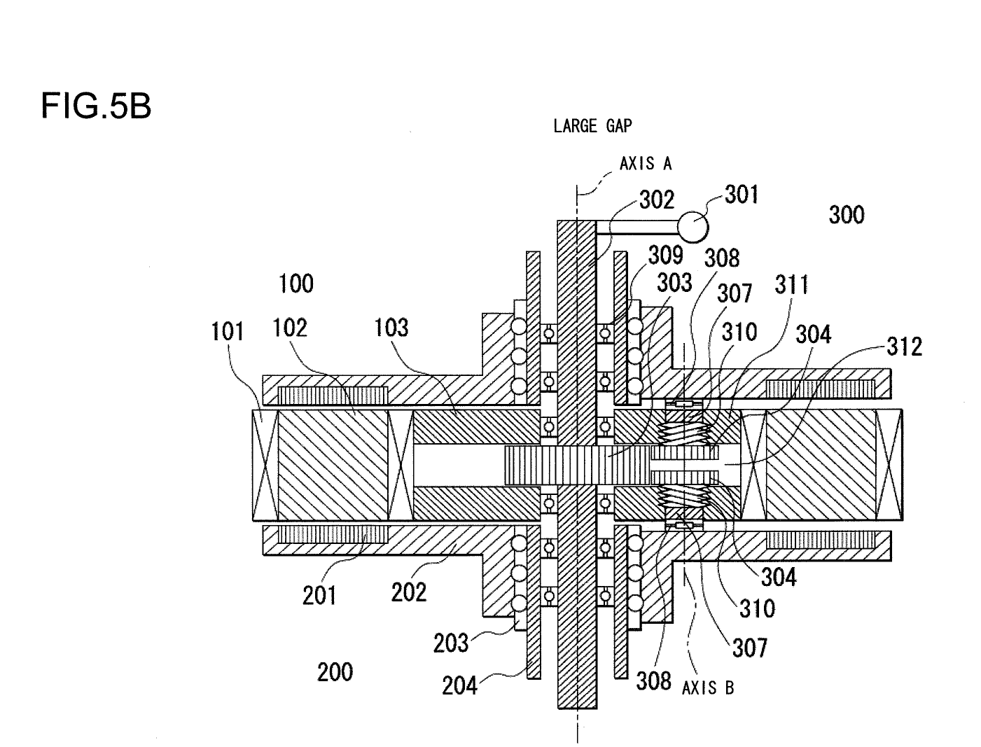

FIGS. 1 through 4 and 5A and 5B show the first embodiment of the axial gap type rotating electrical machine according to the present invention. FIGS. 1, 5A, and 5B are axial sectional views as seen from the radial direction, FIG. 2 is a diametrical sectional view as seen from the axial direction, FIG. 3 is a perspective view of FIG. 2, and FIG. 4 is a sectional view of the perspective view of FIG. 3. Here, the radial direction is a direction orthogonal to the rotational axis of the rotor, and the axial direction is the direction along the rotational axis of the rotor.

The rotating electrical machine, which means here an axial flux permanent magnet brushless machine or an axial gap type rotating electrical machine, according to the present invention includes a stator 100, two rotors 200, a variable gap mechanism 300, and a housing 500.

The stator 100 includes a plurality of coils 101 that are arranged in its circumferential direction around an axis A as a center and a stator core 102 that is disposed inside the coils 101, and is held by the housing 500.

Each of the rotors 200 has the axis A for its rotational axis and includes a plurality of permanent magnets 201 arranged radially outside on the surface opposing the stator 100 in circumferential direction around the axis A as a center and a rotor core 202, and the two rotors 200 are arranged so as to sandwich the stator 100 in the axial direction. The rotor cores 202 are connected to output shafts 204 via ball spline mechanisms 203. The output shafts 204 are mounted in the housing 500 via bearings 501. It should be understood that the housing 500 and the bearings 501 are omitted from FIGS. 2 through 5.

The output shafts 204 are cylindrical, and a first adjustment shaft 302 is mounted in their interiors via bearings 309, so as to be rotatable around the axis A. This first adjustment shaft 302 is connected to an external power source 301. Moreover, the first adjustment shaft 302 is provided with a first gear 303 in a position to oppose the stator. It should be understood that the power source 301 is capable of rotating the first adjustment shaft 302 around the axis A, and is, for example, a servomotor or the like.

A second adjustment shaft 312 is provided at the internal periphery of the stator 100, rotating around an axis B. The second adjustment shaft 312 consists of two shifting shafts 307. Each of these shifting shafts 307 has a second gear 304 and a screw portion 310. The second gears 304 are engaged with the first gear 303. As shown in FIG. 2 (this is a cross section taken in the plane S-S′ in FIG. 1), a total of four of these second adjustment shafts 312 are provided around the first gear 303, i.e. around the axis A.

The screw portions 310 are engaged with nut portions 311 that are connected to the fixing portion 103 of the stator 100. Moreover the screw portions 310 of the two shifting shafts 307 that are positioned above and below in FIG. 1 (i.e. that oppose one another in the axial direction) are formed respectively with normal right-hand thread and reverse thread. Correspondingly, the two nut portions provided respectively to the upper and the lower fixing portions 103 are formed respectively with normal right-hand thread and reverse thread. The second adjustment shafts 312 are coupled to the rotors 200, whose central axis is the axis A, via thrust bearings 308. It should be understood that, in FIG. 4, the fixing portions 103 and the thrust bearing 308 are omitted.

The second adjustment shafts 312 are connected to the power source 301 via the second gears 304, the first gear 303, and the first adjustment shaft 302. In this manner, this first embodiment of the axial flux permanent magnet brushless machine according to the present invention is provided with the variable gap mechanism 300 at the internal periphery of its stator 100. It should be understood that while, as explained above, this variable gap mechanism 300 includes the power source 301, the first adjustment shaft 302, the first gear 303, the second gears 304, the thrust bearing 307, the thrust bearing 308, the bearings 309, the screw portions 310, the second adjustment shafts 312 and so on, it may also be considered as including the surrounding structures to which these are installed.

Next, the operation of this rotating electrical machine according to the first embodiment will be explained. FIG. 5A shows the machine when the gap distance is of normal operation, while FIG. 5B shows it when the gap distance has been increased.

When current is passed through the coils 101, the stator 100 generates a rotating magnetic field. And the rotors 200 rotate about the axis A due to attraction and repulsion between the magnetic field generated by the permanent magnets 201 and this rotating magnetic field. The rotation torque of the rotors 200 is transmitted to the output shafts 204 via the ball spline mechanisms 203, and is thus outputted to the exterior. On the other hand, since the second adjustment shafts are coupled to the rotors 200 via the thrust bearings 308, they experience no influence from the rotation of the rotors 200 and remain stationary. When rotational power is outputted from the power source 301 to the first gear 303, the second gears 304 rotates and the upper and lower shifting shafts 307 move. Due to this, oppositely directed forces along the axial direction are generated upon the upper and lower second adjustment shafts 312. And, because of this, the rotors 200 experience forces from the shafts in opposite axial directions, and are shifted in opposite directions along the axial direction. Thus, at this time, the pairs of rotors 200 that sandwich the stator 100 between them are oppositely shifted along the axial direction.

In this manner, the variable gap mechanism 300 of the first embodiment is driven by the power source 301 that is separate from the rotation mechanism of the rotor 200. Due to this, it is possible to provide flexible control of the gap distances with excellent reliability and responsiveness. Moreover, the same amount of rotational movement is transmitted from the power source 301 to the upper and lower second adjustment shafts 312 at the same moment. Due to this, it is possible to ensure that the amounts of shifting of the upper and lower rotors 200 agree with one another. Furthermore it is possible to provide a system that is compact and of low cost, since it is possible to output the power from a single servomotor in both upper and lower directions. Yet further because, apart from the servomotor, the variable gap mechanism is installed in the interior of this rotating electrical machine, accordingly the system is even more compact.

### Embodiment #2

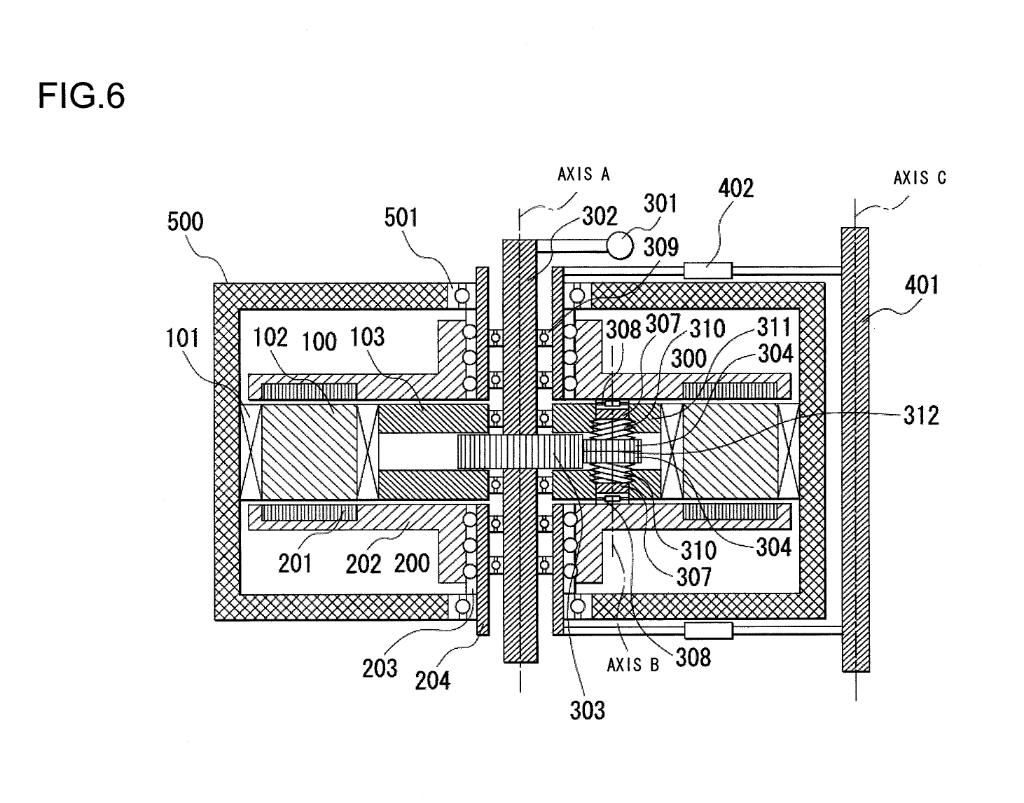

FIG. 6 is a figure showing the second embodiment of the axial gap type rotating electrical machine according to the present invention. In this embodiment, the upper and lower output shafts 204 of the axial gap type rotating machine shown in the first embodiment are connected via torque transmission mechanisms 402 to a single external output shaft 401 that rotates around an axis C exterior to the housing. The torque transmission mechanisms 402 may, for example, be bevel gears or belts or the like.

In this second embodiment, the output torques of the output shafts 204 that rotate around the axis A are transmitted via the torque transmission mechanisms 402 to the external output shaft 401 that rotates around the axis C.

By transmitting the output torques of the upper and lower output shafts 204 to a single shaft in this manner, it becomes possible to ensure that the rotation of the shafts 204 and also their torques agree with one another, even though the output shafts 204 (that are coupled to the rotors 200) are separate from one another.

### Embodiment #3

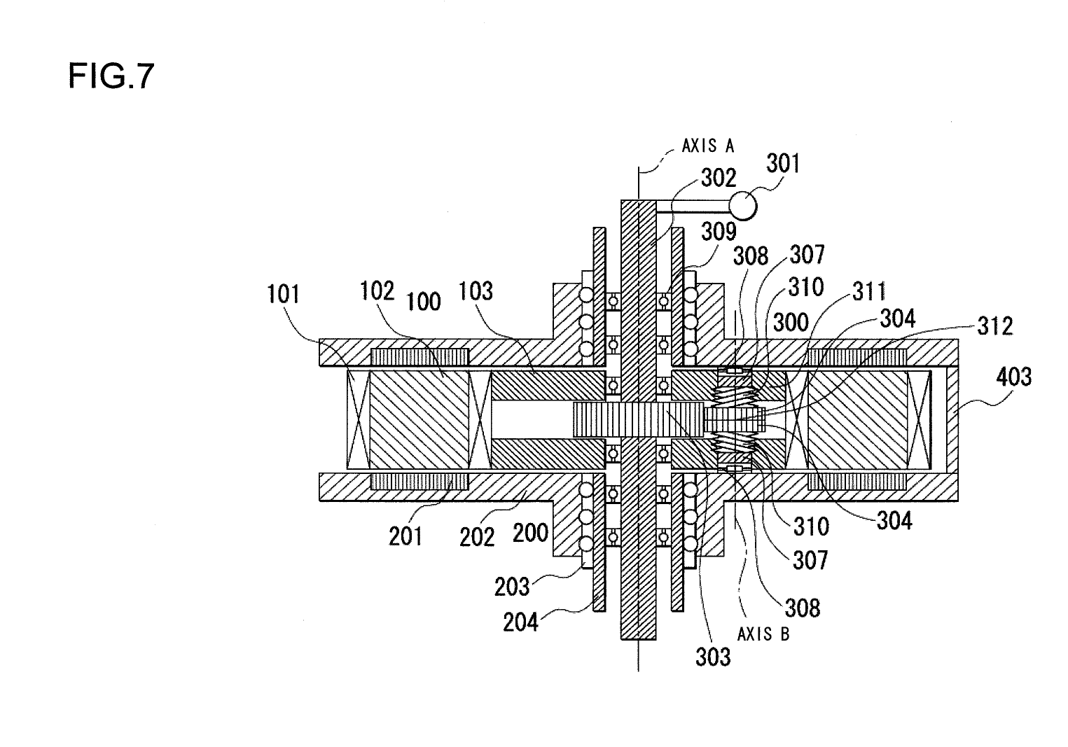

FIG. 7 is a figure showing the third embodiment of the axial gap type rotating electrical machine according to the present invention. It should be understood that, in FIG. 7, the housing 500 and the bearings 501 are omitted.

This embodiment is one in which the relative position in the rotational direction of the upper and lower rotors 200 of the axial gap type rotating electrical machine described in the first embodiment is fixed (while they are free to move relative to one another in the axial direction). This rotating electrical machine according to the third embodiment is provided with a rotor coupling mechanism 403 between the upper and lower rotors 200 for performing this relative rotational fixing. The rotor coupling mechanism 403 is a system for mechanically coupling the relative position of the upper and lower rotors 200 in the rotational direction, and may be, for example, a cylinder or the like. Moreover, one or more rotor coupling mechanisms 403 of this type are provided along the external peripheral portions of the rotors 200 around the axis A; and desirably, in consideration of rotational balance, an even number thereof (i.e. two or more) should be provided symmetrically around the axis A.

Due to this rotor coupling mechanism 403, the upper and lower rotors 200 rotate together due to the rotating magnetic field from the stator 100.

By mechanically coupling together the upper and lower rotors in the rotational direction in this manner, it is possible to ensure that the rotation and the torques of the shafts 204 agree with one another, even though the output shafts 204 to which the rotors are coupled are separate. Moreover, there is no hindrance when varying the distances of the air gaps, since the rotors are not relatively fixed in the axial direction.

### Embodiment #4

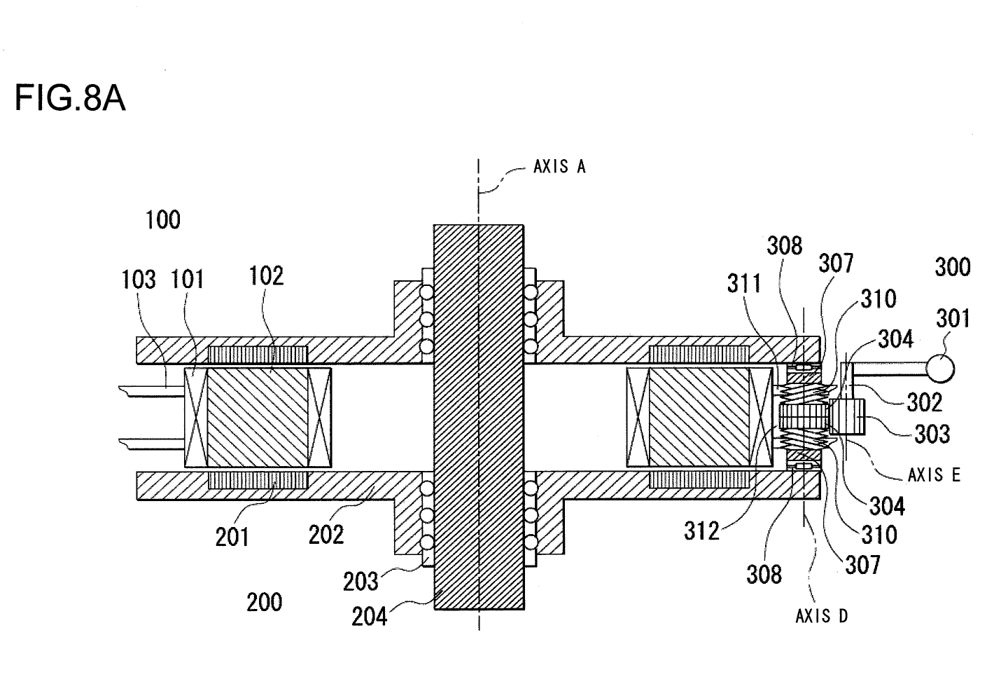

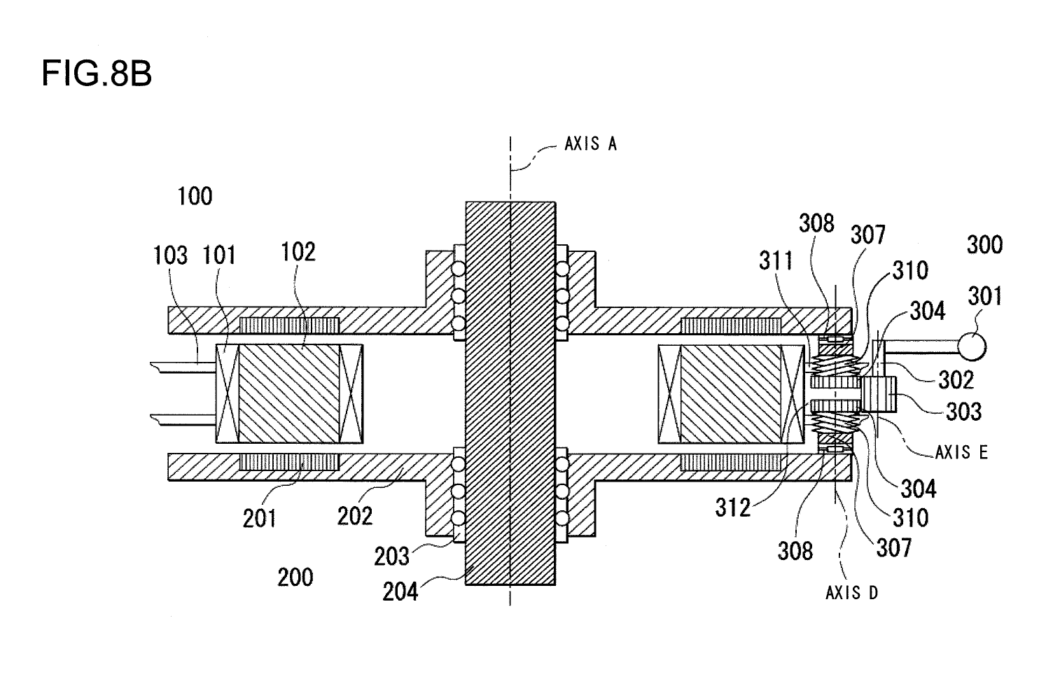

FIGS. 8A and 8B are figures showing the fourth embodiment of the axial gap type rotating electrical machine according to the present invention. FIG. 8 shows the machine when the gap distances is of normal operation, and FIG. 8B shows it when the gap distance has been enlarged. This embodiment is one in which the variable gap mechanism 300 is provided at the external periphery of the stator 100.

Explanation of elements that operate in the same manner as ones in the first embodiment will be omitted. In this fourth embodiment, a second adjustment shaft 312 consisting of paired shifting shafts 307 of upper and lower ones that rotate around a common axis D are provided at the external periphery of the stator 100. A plurality of the second adjustment shafts 312 are provided around the circumferential direction of the device, i.e. around the axis A. Each of the paired shifting shafts 307 has a screw portion 310 that is engaged with a nut portion 311 provided to a fixing portion 103 of the stator 100. The screw portions 310 of the upper and lower shifting shafts 307 are formed respectively with normal right-hand thread and with reverse thread. The shifting shafts 307 are coupled to the rotors 200 that rotate around the axis A, via thrust bearings 307. Moreover, each of the paired shifting shafts 307 is provided with a second gear 304, and is connected to the power source 301 via the first gear 303 and the first adjustment shaft 302 both rotating around axis E.

Next, the operation of this rotating electrical machine according to the fourth embodiment will be explained.

When current is flowed through the coils 101, the stator 100 generates a rotating magnetic field. And the rotors 200 rotate around the axis A due to the attraction and the repulsion between the magnetic field generated by the permanent magnets 201 and this rotating magnetic field. The rotation torque of the rotors 200 is transmitted to the output shaft 204 via the ball spline mechanisms 203, and is outputted to the exterior. On the other hand, since the shifting shafts 307 are connected to the rotors 200 via the thrust bearings 308, they do not experience any influence from the rotation of the rotors 200 and remain stationary. But, when rotational power is outputted to the first gears 303 from the power source 301, the second gears 304 and the upper and lower shifting shafts 307 that are connected thereto rotate. Due to this, the upper and lower shifting shafts 312 generate force in mutually opposite axial directions. And, because of this, the rotors 200 receive force from the second adjustment shaft 312 in the axial direction, and are shifted in the axial direction.

In this manner, the variable gap mechanism 300 of this fourth embodiment is driven by a power source 301 that is separate from the rotation mechanism of the rotors 200. Due to this, it is possible to control the distances of the gaps in a flexible manner with excellent reliability and responsiveness. Moreover, the same amount of rotational power from the power source 301 is transmitted to the upper and lower shifting shafts 307 via the first adjustment shafts 302 at the same moment. Due to this, it is possible to ensure that the amounts by which the upper and lower rotors 200 shift agree with one another. Furthermore, the system is compact and can be made at low cost, since it is possible to output power in opposite directions to both the upper and lower adjustment shafts with a single servomotor.

### Embodiment #5

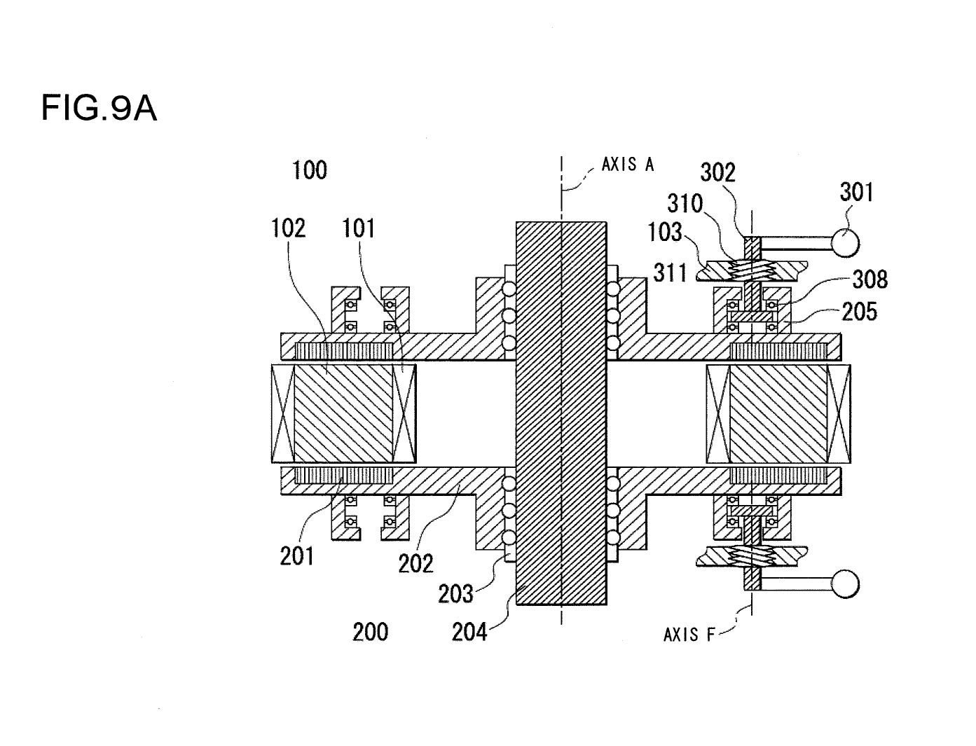

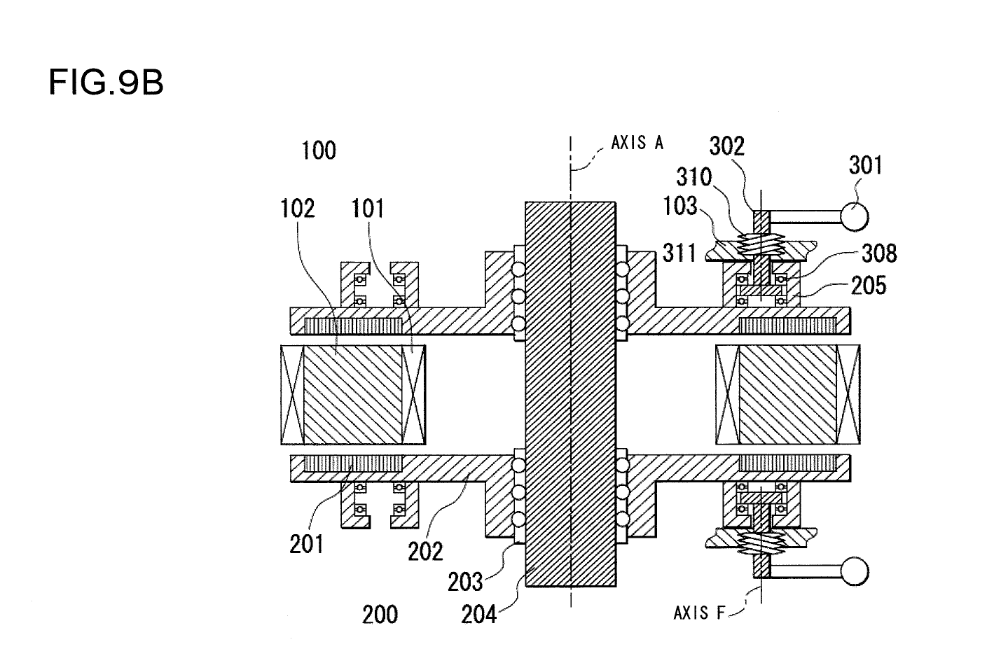

FIGS. 9A and 9B are figures showing the fifth embodiment of the axial gap type rotating electrical machine according to the present invention. FIG. 9A shows the machine when the gap distance is in normal operation, while FIG. 9B shows it when the gap distance has been increased. In the rotating electrical machine of this fifth embodiment, the variable gap mechanism 300 is provided at the outsides of the rotors 200 in the axial direction (i.e. on their sides opposite to their sides that face the stator 100).

Explanation of elements that operate in the same manner as ones in the first embodiment will be omitted. In this fifth embodiment, a projecting portion 205 having a cavity is provided on the end surface of each of the rotor cores 202 (i.e. on its side opposite to its side that faces the stator 100), in the state of being mechanically connected to its corresponding rotor 200. Four thrust bearings 308 that extend around the axis A are disposed within the cavities of the two projecting portions 205. A plurality of first adjustment shafts 302, each of which rotates around an axis F, are provided arranged in the circumferential direction of the motor around the axis A as a center. Each of the first adjustment shafts 302 has a screw portion 310, and this screw portion 310 is engaged with a nut portion 311 that is provided to a fixing portion 103 of the housing 500 (not shown in the figure) that supports the stator. Furthermore, the first adjustment shafts 302 are connected to an external power source 301.

Next, the operation of this rotating electrical machine according to the fifth embodiment will be explained. When current is flowed in the coils 101, the stator 100 generates a rotating magnetic field. And, due to attraction and repulsion between the magnetic fields generated by the permanent magnets 201 of the rotors 200 and this rotating magnetic field, the rotors 200 rotate around the axis A. The rotational torque of the rotors 200 is transmitted to the output shaft 204 via the ball spline mechanisms 203, and is outputted to the exterior. The projecting portions 205 and the thrust bearings 308 rotate together with the rotors 200. On the other hand, the rotational torque of the rotors 200 is not transmitted to the first adjustment shafts 302, since they are coupled to the rotors 200 via the thrust bearings 308. And, when the first adjustment shafts 302 receive rotational power from the power source 301, they generate force in the axial direction due to their screw mechanisms. Because of this, the rotors 200 experience force in the axial direction from the first adjustment shafts 302, so that the rotors 200 are shifted in the axial direction.

Thus, the variable gap mechanism 300 of the fifth embodiment is driven by the power source 301, that is separate from the rotation mechanism that includes the rotors 200. Due to this, it is possible to control the distances of the air gaps in a flexible manner with excellent reliability and responsiveness. Moreover, a greater drive force is obtained with this rotating electrical machine of the fifth embodiment as compared to the structure of the rotating electrical machines of the first through the fourth embodiments, since an individual power source 301 is provided to each of the upper and lower rotors 200 in the axial direction. Because of this, it is possible to perform more reliable control of the gap distances even if, for example, the physical structure of the motor is large and the magnetic attraction that acts between the stator and the rotor is great.

It should be understood that none of the various embodiments that have been explained above are to be considered as being limited by the feature that the variable gap mechanisms 300 are provided in plurality around the axis A as a center, as shown by way of example; in each case, it would also be acceptable for only one such variable gap mechanism 300 to be provided. While the power source 301 is used as the power source for the variable gap mechanism 300, it would also be acceptable to employ some other power source, provided that it is one that can transmit rotational power to the first adjustment shafts 302 and that is different from the rotational power of this axial gap type rotating electrical machine itself, in other words provided that it is an external power source. It would also be acceptable for the screw portion 310 and the nut portion 311 to be constituted as a ball screw mechanism, in order to reduce friction.

Moreover, it is desirable for the stator core 102 to be made from a soft magnetic material such as magnetic steel sheet, an amorphous metal, electromagnetic stainless steel, or the like, and it is likewise desirable for the rotor cores 202 to be made from a soft magnetic material such as magnetic steel sheet, an amorphous metal, electromagnetic stainless steel, or the like. Furthermore, the rotor cores 202 may be annular and of approximately the same diameter as the permanent magnets 201, and may be connected to the shaft via a constructional member that holds them. It is desirable to utilize S45C, SS400, stainless steel, or the like for this constructional member. Moreover, it would also be acceptable to employ an annular permanent magnet that is polar anisotropy magnetized. It would also be possible to arrange the rotors 200 to be built up from the permanent magnets 201, annular rotor cores made from a soft magnetic material that form magnetic circuits together with the permanent magnets 201, and members that mechanically couple these to the output shaft 204.

The axial flux permanent magnet brushless machine, which is a type of rotating electrical machine and is referred also as an axial gap type rotating electrical machine, according to the invention of the present application has a double rotor construction that employs two rotors. According to this double rotor construction, as compared with a single rotor construction, it is possible to increase the efficiency of utilizing the rotating magnetic field and to obtain a larger torque.

With the axial flux permanent magnet brushless machines of the embodiments described above, in all cases, flexible control of the gap distances with excellent reliability and responsiveness is possible.

Next, the control of the gap distances will be explained. A power source control device (not shown in the figures) is provided for the power source 301, and, by outputting a control signal to the power source 301 specifying the timing at which it is to rotate, this control device drives the first adjustment shaft 302, the first gear 303, and the second gears 304, and thus adjusts the distances of the two gaps.

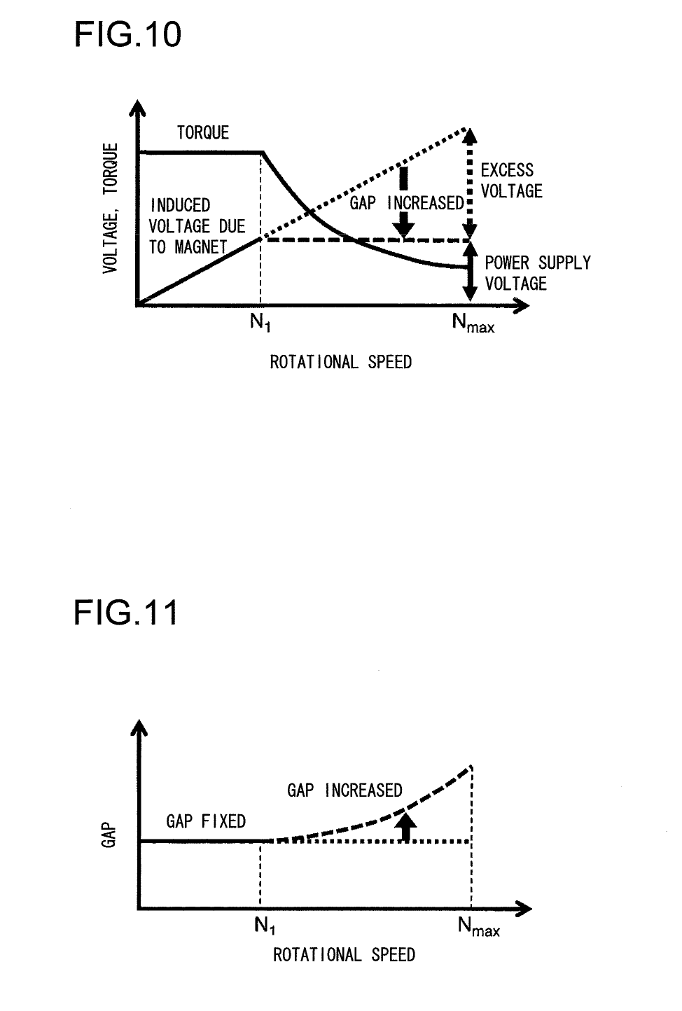

FIGS. 10 and 11 are figures showing, for this axial flux permanent magnet brushless machine, the relationship between rotational speed and voltage and torque, and the relationship between rotational speed and the gaps, when the variable gap mechanism 300 is provided so as to be able continuously to control the gaps. FIG. 10 shows the relationship between rotational speed and voltage and torque, and FIG. 11 shows the relationship between rotational speed and the gaps.

With the axial flux permanent magnet brushless machine according to the present invention, by increasing the gaps, the magnetic flux that links through the coils can be weakened, so that the induced voltage can be kept down to less than or equal to the power supply voltage.

For example, in the case of a motor for propelling an electric automobile or a hybrid electric automobile, a broad rotational speed region is employed in order to be able to cope with starting off the automobile off from rest, climbing hills, high speed travel, and so on. When utilizing an axial flux permanent magnet brushless machine according to the present invention as such a propulsion motor, then the low rotational speed high torque region in FIG. 10 is used when starting off from rest or when climbing a hill, while the high rotational speed region is used during high speed travel.

The drive motor generates induced voltage in proportion to the rotational speed, according to the change over time of the magnetic flux that links through the coils. When this induced voltage becomes higher than the power supply voltage at some predetermined rotational speed (greater than or equal to N1), then it becomes impossible to supply the current required from the power supply side to generate the necessary torque.

In this case, the control device described above supplies a control signal to the power source 301 for increasing the distances of the gaps, and, upon receipt of this control signal and on the basis thereof, the power source 301 drives the first adjustment shaft 302 so that the distances of the gaps become greater. Due to this, it is possible to increase the gap distances during high speed rotation at rotational speeds greater than or equal to N1, so that it is possible to suppress the induced voltage, and thus to supply an electrical current that is adequate for production of the required torque.

Conversely, for example during braking operation, the control device described above supplies a control signal to the power source 301 for reducing the distances of the gaps, and, upon receipt of this control signal and on the basis thereof, the power source 301 drives the first adjustment shaft 302 so that the distances of the gaps become narrower. Due to this, the motor functions as a load, and the braking effect provided thereby is increased. At the same time, it is possible to recover the kinetic energy of the vehicle to the battery in an efficient manner.

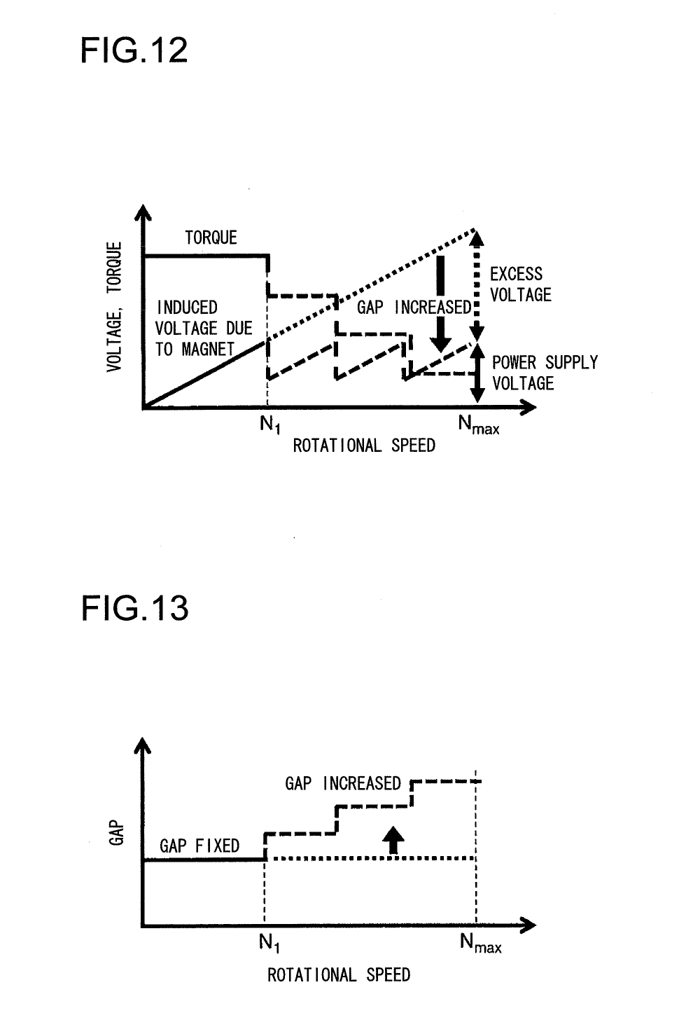

It would also be acceptable to arrange for the gap control to be performed discretely, i.e. stepwise. By doing this, it is possible to simplify the control system for the power source 301. FIGS. 12 and 13 show, respectively, the relationship between rotational speed and voltage and torque, and the relationship between rotational speed and the gaps, when the mechanism for controlling the variation of the gaps operates discretely.

It should be understood that it is also possible to control the gaps when no current is being passed through the coils (i.e. when no torque is being outputted). Thus it is possible, during braking operation, to increase the braking force by narrowing down the gaps; and, during coasting traveling under the force of inertia or downhill traveling under the force of gravity, it is possible to reduce the generation of loss by increasing the gaps.

It should be understood that the rotating portions of the above explained thrust bearings 308 in FIGS. 1 through 8 may be placed either on the side of the rotor core 202 or on the side of the shifting shaft 307. When the thrust bearings 308 are placed on the rotor side, though an detailed illustration of the bearings is omitted in the figures, an annular metal plate, for example, is installed between the shifting shaft 307 and the thrust bearings 308.

Summarizing the above explanations, according to the present invention, it is possible to supply an axial flux permanent magnet brushless machine of a double rotor construction, in which the reliability of the variable gap mechanism is enhanced, and in which it is possible to change the gap distance between the stator and the rotor in a flexible manner

The above described embodiments are examples, and various modifications can be made without departing from the scope of the invention.

What is claimed is:

1. An axial flux permanent magnet brushless machine comprising:
a housing;
a stator comprising a stator core and a coil;
two rotors each including a permanent magnet, and positioned so as to sandwich the stator in the axial direction with air gaps being left between the rotors and the stator; and
a variable gap mechanism for changing distances of the air gaps;
wherein the variable gap mechanism operates from a power source that supplies other rotational power than a rotational power of the axial flux permanent magnet brushless machine, and changes the distances of the air gaps by shifting the rotors in the axial direction.

2. An axial flux permanent magnet brushless machine comprising:
a housing;
a stator comprising a stator core and a coil;
two rotors each including a output shaft and a permanent magnet, and positioned so as to sandwich the stator in the axial direction with air gaps being left between the rotors and the stator;
a variable gap mechanism for changing distances of the air gaps; and
a power source that supplies other rotational power than a rotational power of the axial flux permanent magnet brushless machine, and drives the variable gap mechanism;
wherein the variable gap mechanism comprises two shifting shafts each with a screw portion and a gear portion and two nut portions each supporting the screw portion, and the screw portion is connected to the power source, and the variable gap mechanism shift the rotors due to movement of the shifting shafts each by rotation of the screw portion by the power source.

3. An axial flux permanent magnet brushless machine according to claim 2, wherein:
the rotors comprise connection portions that are connected with the shifting shafts; and
the connecting portions include thrust bearings provided on a surface to which the shifting shafts are connected, so that the rotors can rotate assuming the output shaft as its rotation axis.

4. An axial flux permanent magnet brushless machine according to claim 3, wherein the engagement portions include bearings provided on the sides of the shifting shafts towards the rotors, so that the rotors can rotate assuming the output shaft as its rotation axis.

5. An axial flux permanent magnet brushless machine according to claim 2, wherein the variable gap mechanism is disposed at the external periphery of the stator, and the screw portion of one the two shifting shafts is reverse threaded against the screw portion of the other one of the two shifting shafts, and the two nut portions are fixed to the stator.

6. An axial flux permanent magnet brushless machine according to claim 2, wherein the variable gap mechanism is disposed at the internal periphery of the stator, and the screw portion of one the two shifting shafts is reverse threaded against the screw portion of the other one of the two shifting shafts, and the two nut portions are fixed to the stator.

7. An axial flux permanent magnet brushless machine according to claim 6, wherein:
the output shaft comprises two output shafts each provided to respective rotors, each of the two output shafts is connected via a ball spline mechanisms to the respective rotor, and in the interiors of the two output shafts, power transmission mechanisms that transmit power from the power source to the screw portion of the shifting shaft.

8. An axial flux permanent magnet brushless machine according to claim 7, wherein the power transmission mechanism comprises a first gear that is connected to the power source and a second gear that is the gear portion of the shifting shaft, and power of the power source is transmitted by engaging the first gear and the second gear.

9. An axial flux permanent magnet brushless machine according to claim 6, wherein the two output shafts are coupled to a single external output shaft exterior to the housing.

10. An axial flux permanent magnet brushless machine according to claim 6, wherein a rotor coupling mechanism is provided between the two rotors and mechanically fixes their relative position in the rotational direction.

11. An axial flux permanent magnet brushless machine according to claim 10, wherein the rotor coupling mechanism is a cylinder.

12. An axial flux permanent magnet brushless machine according to claim 2, wherein the rotor core is made from magnetic steel sheet, amorphous metal, or electromagnetic stainless steel.

13. An axial flux permanent magnet brushless machine according to claim 2, wherein the permanent magnet is an annular polar anisotropy magnetized magnet.

14. An axial flux permanent magnet brushless machine according to claim 2, wherein the stator core is made from magnetic steel sheet, amorphous metal, or electromagnetic stainless steel.

15. An axial flux permanent magnet brushless machine according to claim 2, wherein the power source is a servomotor.
